(19) United States
(12) Patent Application Publication
(10) Pub. No.: US 2019/0007329 A1
(43) Pub. Date: Jan. 3, 2019

(54) METHOD FOR ENFORCEMENT OF NON-IP DATA POLICING OVER THE SERVICE EXPOSURE FUNCTION

(71) Applicant: NEC Corporation, Tokyo (JP)

(72) Inventors: Genadi VELEV, Heidelberg (DE); Iskren IANEV, Heidelberg (DE); Toshiyuki TAMURA, Tokyo (JP)

(21) Appl. No.: 15/755,462

(22) PCT Filed: Feb. 6, 2017
(86) PCT No.: PCT/JP2017/004182

§ 371 Date: Feb. 26, 2018

(30) Foreign Application Priority Data
Feb. 17, 2016 (EP) 16275028.5

(51) Int. Cl. H04L 12/823; H04L 12/825

(52) U.S. Cl. CPC H04L 47/32; H04L 47/25

(57) ABSTRACT

The invention describes a solution for configuration of policy and other QoS parameters for the non-IP data transmission path over SCEF. Policy enforcement in UL and DL are proposed to avoid the excessive data transmission to/from IoT or M2M devices.

### TECHNICAL FIELD

This invention relates to method for enforcement of non-IP data policing over service exposure function.

### BACKGROUND ART

The following abbreviations and terminology (whenever differently stated) are used in the current invention:

TABLE 1

| | |
|---|---|
| 3GPP | 3^{rd} Generation Partnership Project |
| AS | Access Stratum (use similar to RRC signaling in this |
| | invention) |
| DCN | Dedicated Core Network |
| NB, eNB | Node B, evolved Node B (but can also be any ‘RAN node’ |
| | implementing 2G, 3G, 4G or future 5G technology) |
| E-UTRAN | Evolved Universal Terrestrial Radio Access Network (also |
| | used as EUTRAN) |
| GGSN | Gateway GPRS Support Node |
| GPRS | General Packet Radio Service |
| HPLMN | Home Public Land Mobile Network |
| HSS | Home Subscriber Server |
| IE | Informational Element (used as part of a signalling message) |
| MME | Mobility Management Entity |
| MNO | Mobile Network Operator |
| NAS | Non Access Stratum |
| NFV | Network Function Virtualization |
| NNSF | NAS/Network Node Selection Function |
| PCRF | Policy and Charging Rules Function |
| PGW | Packet Data Network Gateway |
| PSM | Power Saving Mode |
| RAU | Routing Area Update |
| RNC | Radio Network Controller |
| RRC | Radio Resource Control |
| PLMN | Public Land Mobile Network |
| SGSN | Serving GPRS Support Node |
| SGW | Serving Gateway |
| TAU | Tracking Area Update |
| UE | User Equipment |
| UTRAN | UMTS Terrestrial Radio Access Network |
| VPLMN | Visited Public Land Mobile Network |

The following terminologies are used within this invention.

The terms ‘serving node’ or ‘MME/SGSN’ or ‘MSC/SGSN/MME’ or C-SGN (CIoT Serving Gateway Node) is generally used through the various embodiments of this invention to describe a functional entity like MSC, or SGSN or MME, or C-SGN or other possible control plane functional entity in the mobile network which terminate the control plane signalling (known as NAS signalling) between the core network and the terminal. The serving node (MME/SGSN) can be also a functional entity from future generation networks which is responsible for mobility and session management. The term HSS/HLR means the repository where the UE's subscription data is stored and can be either an HSS or an HLR or a combined entity.

The terms ‘terminal’, or ‘device’, or ‘user terminal’ or ‘UE’ (User Equipment) or ‘MT’ (Mobile Terminal) are used in an inter-exchangeable manner where all of the terms express the similarly the equipment used to send/receive data and signalling from network or mobile network or radio access network.

In the recent years due to the penetration of Internet of Things (IoT) and Machine-to-Machine (M2M) technologies the standard bodies like 3rd Generation Partnership Project (3GPP) start working on improvements known as Machine Type Communication (MTC) since Release 10. In order to even more reduce the price of end devices and the price in the operator's network for serving such devices, 3GPP carried out a work called Cellular IoT (CIoT). This work studied and evaluated the architecture enhancement to support ultra-low complexity, power constrained, and low data-rate IoT devices. The documentation of this study is captured in the document 3GPP TR23.720. The conclusions were 1) to specify a mandatory control plane (CP) solution, which is documented in section 2 in the TR and 2) to specify optionally user plane (UP) solution, which is documented in section 18 in the TR. Therefore the CP solution is also referenced as ‘solution 2’ and the UP solution is referenced as ‘solution 18’.

The EPS optimized for CIoT supports traffic pattern that is different as compared to the normal UEs and may support only sub-set and necessary functionalities as compared with the existing EPS. An EPS optimized for CIoT can be enabled by having sub-set of functionalities implemented in single logical entity C-SGN (CIoT Serving Gateway Node). Mobility and Attach procedures are performed as described in other clauses for corresponding entities MME, S-GW and P-GW. An example single node non-roaming CIoT architecture is shown in FIG. 1. The detailed description of the reference points (interfaces) can be found in specification 3GPP TS23.401 and 3GPP TS23.682.

The selection between CP or UP solution happens during Attach procedure or during a TAU procedures. The UE indicates a ‘Preferred Network Behaviour’ including the following:
Whether Control Plane CIoT EPS optimisation is supported;
Whether User Plane CIoT EPS optimisation is supported;
Whether Control Plane CIoT EPS optimisation is preferred or whether User Plane Plane CIoT EPS optimisation is preferred;
Whether Si-U data transfer is supported;
Whether SMS transfer without Combined Attach is requested;
Whether Attach without PDN Connectivity is supported.

The serving node sends in the Attach or TAU accept message the ‘Supported Network Behaviour’ information.

In the CIoT EPS optimisations the UE can support “Attach without PDN connectivity”, which mean that no PDN connectivity, and thus, no EPS bearers are established during the Attach procedure. The UE can request a PDN connectivity (IP or non-IP) at later point of time using NAS (E)SM signaling.

If the serving node configures the CP CIoT EPS optimization to be used, the data is transferred between UE and the serving node in NAS PDUs including the EPS bearer Identity of the PDN connection they relate to. Both the IP and non-IP data types are supported. This is accomplished by using the NAS transport capabilities of RRC and S1-AP protocols and the data transport of GTP-u tunnels between MME and S-GW and between S-GW and P-GW or if a Non-IP connection is provided by via the MME with the SCEF, then data transfer occurs as indicated in TS 23.682 [74].

FIG. 2 shows a signaling flow of mobile originated (MO) data transmission for Control Plane CIoT EPS Optimisation (i.e. CP solution). This figure is according to TS23.401. When using CP solution for user data transport, the MME (for uplink, UL) and UE (for downlink, DL) uses the EPS Bearer identity (EBI) contained within the NAS PDUs to identify the associated EPS bearer.

If the MME wishes to use the CP solution for mobile terminating (MT) services, then an example procedure is shown in FIG. 3 from TS23.401.

The CIoT EPS optimisations can also apply to LTE (EUTRAN) system. In particular, the main intention is to cover wide-band (WB) EUTRN UEs (e.g. cat-M) with low cost properties. However, if a WB EUTRAN UE capable of NB-IoT uses NB-IoT solutions (CP or UP solution), there could be several restrictions when changing RATs. For example, if the UE has activated non-IP connection, then the UE may not reselect 2G/3G access and continue using the non-IP connection.

The non-IP Data Delivery (NIDD) via SCEF will be capture in 3GPP TS23.682, as currently the 3GPP Tdoc S2-160832 (which needs to be implemented in TS23.682) shows the procedures. NIDD may be used to handle mobile originated (MO) and mobile terminated (MT) communication with UEs, where the packets used for the communication are not based on the internet protocol (IP). The configuration of the SCEF for the delivery of the non-IP data is shown in FIG. 4 description and detailed description can be found in 3GPPTdoc S2-160832.

For example purposes, FIG. 5 shows the procedure using which the SCS/AS sends non-IP data to a given user as identified via External Identifier or MSISDN. This procedure assumes that procedures in establishment of EPS bearer for non-IP data and SCEF configuration procedure (as per FIG. 4) are completed.

### CITATION LIST

### Non Patent Literature

[NPL 1]

3GPP TS23.401 v144.0, General Packet Radio Service (GPRS) enhancements for Evolved Universal Terrestrial Radio Access Network (E-UTRAN) access; Stage 2, v13.5.0, 2015-12
[NPL 2]

3GPP TR23.720, Architecture enhancements for Cellular Internet of Things; v1.2.0, 2015-11
[NPL 3]

3GPP TS123.203, Policy and charging control architecture; v13.5.1, 2015-09

### SUMMARY OF INVENTION

### Technical Problem

Problem Description

One important feature/characteristic, which is considered for network design, is the data rate (or data amount or number of transmissions per time period) transmitted over a certain period of time. Usually the data rate is measured in bits per second, whereas data amount is measured in bytes per hour or per day or per week, etc. Measures for data rate limitation or throttling can be taken by the network if the data rate exceeds certain limit or allowed data rate. Usually the data rate limitation or traffic shaping over the UP is performed in the PGW (for DL data) and at eNB for UL data. Since non-IP data is considered to be transmitted over CP only and may be routed from the serving node towards SCEF, new mechanisms (not currently available) are needed. In particular, mechanism(s) is needed to limit the data rate in both uplink (DL) and downlink (DL) for non-IP data transmission (also known as NIDD).

In addition to the data rate limitation, data amount limitation, number of data transmissions limitation, etc., for non-IP data different priorities or QoS parameters can be applied. Currently there are no mechanisms to deal with such features.

A situation for data rate exceed can happen if an application of an UE or an application in Application server (AS) misbehaves.

### Solution to Problem

In one aspect, the invention provides a rate controlling method for non-IP data using CIoT EPS optimization, comprising: limiting a message rate of the non-IP data based on at least one of a configured message rate control parameter in a Service Capability Exposure Function, SCEF, and based on an indicated message rate control parameter by a core network node.

In one aspect, the invention provides a control node for non-IP data using CIoT EPS optimization, comprising: means configured to limit a message rate of the non-IP data based on at least one of a configured message rate control parameter in a Service Capability Exposure Function, SCEF, and based on an indicated message rate control parameter by a core network node.

In one aspect, the invention provides a rate controlling method for non-IP data using CIoT EPS optimization, comprising: informing a user equipment, UE, and a SCEF, Service Capability Exposure Function, of a message rate control that a serving PLMN (Public Land Mobile Network) intends to limit a message rate of the non-IP data based on an indicated message rate control parameter.

In one aspect, the invention provides a core network node for rate controlling of non-IP data using CIoT EPS optimization, comprising: means configured to inform a user equipment, UE, and a SCEF, Service Capability Exposure Function, of a message rate control that a serving PLMN (Public Land Mobile Network) intends to limit a message rate of the non-IP data based on an indicated message rate control parameter.

In one aspect, the invention provides a communication method used in a user equipment, UE, for non-IP data using CIoT EPS optimization, comprising: receiving a message rate control parameter from a core network node; and limiting a message rate at which the UE generates uplink data to comply with a policy corresponding to the message rate control parameter.

In one aspect, the invention provides a User Equipment, UE, for rate controlling of non-IP data using CIoT EPS optimization, comprising: receiving means configured to receive a message rate control parameter from a core network node; and limiting means configured to limit a message rate at which the UE generates uplink data to comply with a policy corresponding to the message rate control parameter.

### Advantageous Effects of Invention

(1) Dynamic policy enforcement over SCEF is applied without the involvement of PCRF.
(2) The policy enforcement includes the amount/volume of data transmitted over large period of time (e.g. day, week). The application at SCS/AS is informed in case or enforced data limitation.

### BRIEF DESCRIPTION OF DRAWINGS

FIG. 1 shows an example single node non-roaming CIoT architecture.

FIG. 2 shows a signaling flow of mobile originated (MO) data transmission for Control Plane CIoT EPS Optimisation (i.e. CP solution).

FIG. 3 shows signaling flow for MT Data transport in NAS PD s.

FIG. 4 shows configuration if SCEF for NIDD procedure.

FIG. 5 shows the procedure using which the SCS/AS sends non-IP data to a given user as identified via External Identifier or MSISDN.

FIG. 6 shows signaling flow for policy information setup in the SCEF.

FIG. 7 shows the T6 reconfiguration (or modify) procedure.

FIG. 8 shows a possible solution for enforcement of data limitation in the DL.

FIG. 9 shows an example signaling flow for the solution of data rate limitation enforcement for UL data.

FIG. 10 shows a block diagram for UE.

FIG. 11 shows a block diagram for RAN node.

FIG. 12 shows a block diagram for serving node.

FIG. 13 shows a block diagram for HSS/HLR or SCFF.

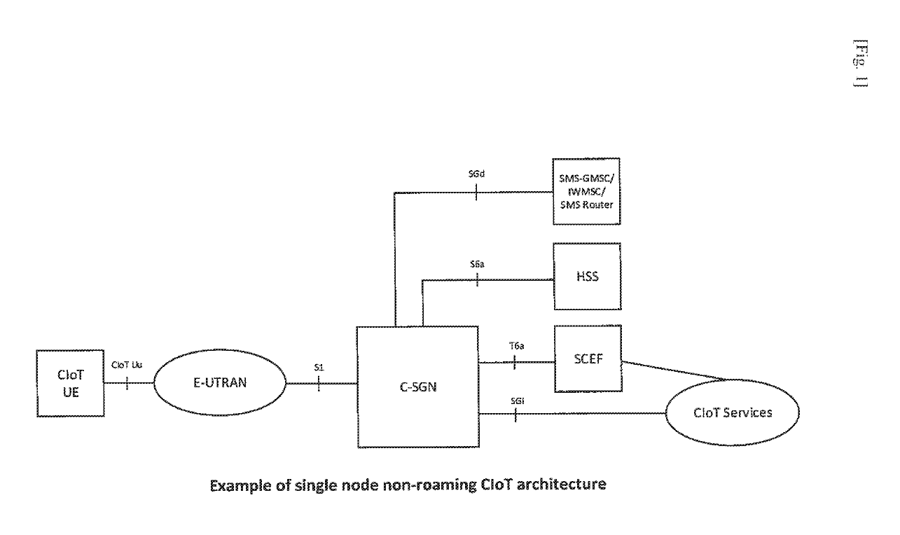

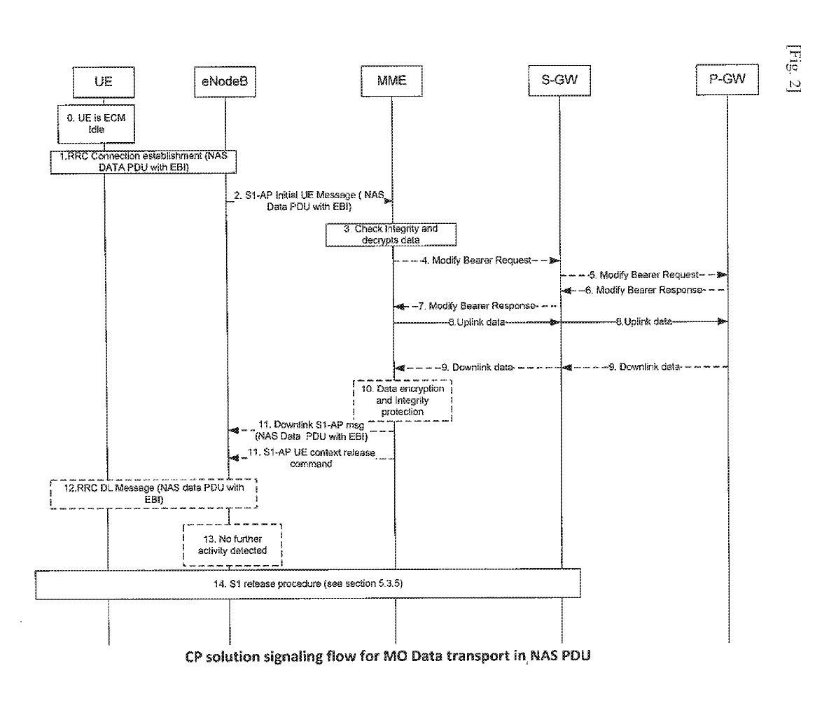

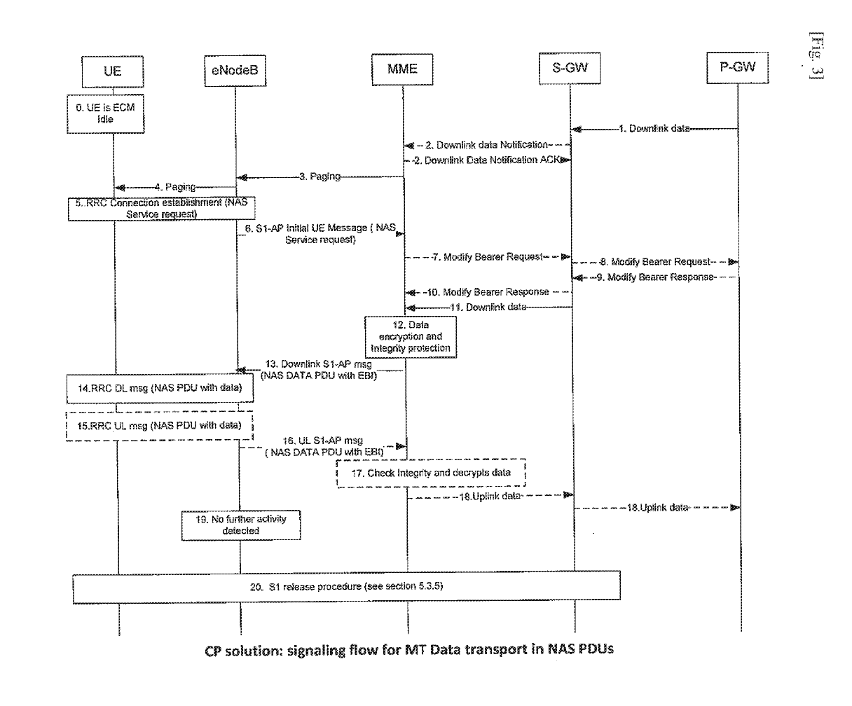

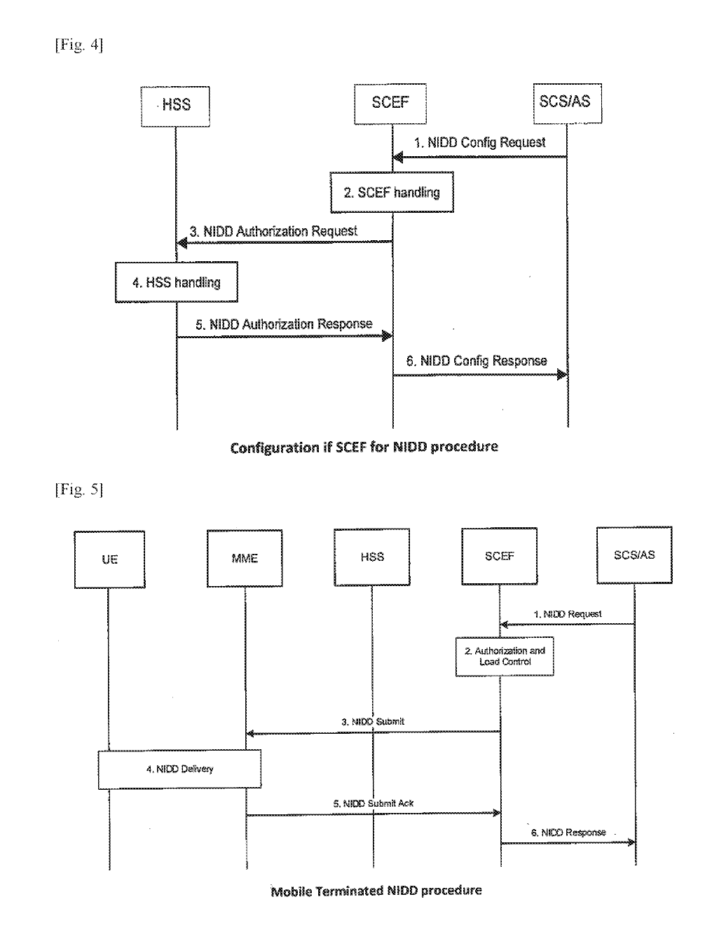

### DESCRIPTION OF EMBODIMENTS

In order to solve the above described problem, different solutions are described in various embodiments herewith.

As described in the problem description in this invention, it is assumed that non-IP data is transferred over the control plan (CP) encapsulated in NAS PDUs between the UE and serving node (MME). For the transmission of non-IP data, one or multiple non-IP bearers can be setup depending on the number of applications using non-IP data and the configuration of the UE or service agreement between the service provider and network operator. For example in one configuration multiple Application can be configured to use the same APN, or in another configuration each application can be configured with a separate APN. The setup of a non-IP bearer can happen in advance before the UE's application or the application on the network side (i.e. SCS/AS) start sending data. This is sometimes needed especially for the MT data transmission (or DL data) as the SCEF need to be configured with routing information, e.g. for the connection establishment over the T6 (or T6a or T6b) interface.

The solution introduced herewith is referred as solution 1.

Once the application in the UE and AS start exchanging data in UL or DL, some functional entity in the 3GPP domain needs to perform traffic counting and charging policy functionality. This functionality is similar to the functionality performed by PCEF, which is considered as part of PGW, where the data counting in UL and DL is performed, charging records are generated, traffic shaping can be applied, etc., based on either preconfigured policy or via a dynamic policy exchange with the PCRF.

This solution proposes that such policy functionality is performed by the SCEF. The SCEF can apply one of the following policies or any conibinations of them: DL rate limitation (per bearer or for all non-IP bearers), or UL rate limitation (per bearer or for all non-IP bearers), or limitation of data rate per bearer, or limitation of data rate for all non-IP bearers (optionally for both UL and DL together). One example of data rate can be 2000 bytes per day in UL and 4000 bytes of data in the DL; whereas another example can be that all non-IP data sent in both UL and DL per day do not exceed 10 Kbytes. After detecting that a data limit was hit, SCEF may execute certain actions.

One problem to solve is how the policy information for rate limitation per bearer or aggregated rate for all non-IP bearers or other limitation parameters (e.g. which time period of the day transmission is allowed to/from a UE) is configured in the SCEF. In this invention the information to be configured in the SCEF is referred as ‘policy information’ and includes, but not limited to:
Gating control: including the limitation of maximum data amount to be transmitted per UE, or per APN, or per PDN connection, or per bearer, etc. For example this parameter can be 3000 bytes per day or 10 Kbytes per week, or similar.

Alternatively another limitation can be the aggregated maximum data rate, e.g. 200 bits per second. One such existing parameter, which can be used, is the AMBR (Aggregate Maximum Bit Rate), which is applicable e.g. per UE, e.g. called UE-AMBR applicable separately for both UL and DL.
QoS control, including (1) the prioritization of a single non-IP data packet related to other non-IP packets within a single bearer or (2) the prioritization of one non-IP bearer over other(s) non-IP bearer.
Usage Monitoring Control: to apply usage monitoring for the accumulated usage of network resources on a per non-IP bearer/session and user basis;
Other information for traffic policy as per TS23.203.

For the gating (or other data limitation) functionality in the SCEF there are several alternatives possible. At least one of following information can be exchanged instead of “maximum data amount”.

a) total data volume which UE allowed receive or send for a certain period (e.g. minute/hour/day/week);

b) max throughput or data rate (per certain period(e.g. second/hour/day/week):

c) max number of single transmissions, e.g. transmission of non-IP packets (per certain period(e.g. second/hour/day/week));

d) a flag to indicate if total data volume which UE will receive exceeds/lowers a threshold.

Also, two or more parameters among a)-d) can he exchanged together as the alternative information.

In general, it is proposed that the ‘policy information/parameters’ for the non-IP connection(s) (meaning for non-IP APNs) is configured and stored in the SCEF. The following options can be used to configure the SCEF with the ‘policy information/parameters’:
A. SCEF is statically configured by the operator (similar what is available today for PCEF). This can be applied for example by preconfiguring specific policies per APN. Each UE having a connection over the SCEF and using the specific APN would be under the constraints of the pre-configured policies for this APN.
B. SCEF is configured via the HSS/HLR (basically the UE subscription repository).
C. SCEF is configured via the serving node (e.g. MME or SGSN) during the establishment of T6 connection.
D. SCEF is configured via the PCRF.

The applicability of option D is a bit questionable, as for a cheap IoT devices there may not be provisioning in the PCRF. One reason to limit the network operational costs and avoid PCRF provisioning, but also other reason can be that there are no GBR or dedicated bearers foreseen to be used for IoT devices.

Option B can be performed during the establishment of T6 connection (PDN connection) between the SCEF and MME for a given UE. It is proposed that the SCEF fetches the UE's subscription (or the relevant part of the UE's subscription) from the HSS/HLR in order to store e.g. the UE's External ID or other parameters. During this exchange between SCEF and HSS/HLR the SCEF receives also the subscription parameters related to the non-IP APN(s) and the corresponding subscribed policy information (e.g. AMBR, amount/volume of data limitation, QoS information, etc.). Then the SCEF uses this subscription data to configure the policies to be applied to the UE, or more specifically to a given PDN connection.

Option B can be performed during the NIDD configuration procedure shown on FIG. 4. During the exchange between SCEF and HSS the signaling can be extended to include ‘policy information/parameters’ for example in the NIDD Authorization Response (Result) message. A new format of this message can be:

NIDD Authorization Response (Result, APN (or UE) policy rules/information for non-IP) message.

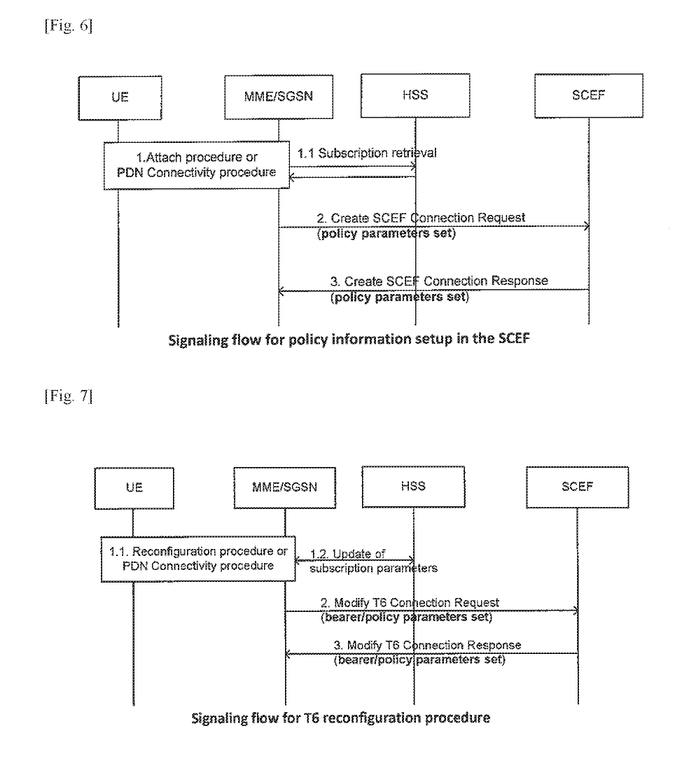

In the following, the configuration option C is described in details. The configuration with the policy information is performed during the connection setup over the T6a/T6b interface. This is exemplary shown on FIG. 6.

The support of accounting functionality in SCEF for NIDD is optional. Depending on operator configuration the MME, SCEF and IWK-SCEF support accounting functionality for NIDD via SCEF.

Accounting information shall be generated for every NIDD request and response messages. Accounting information, e.g. number of successful NIDD Submit Request, number of failed NIDD Submit Request etc is collected by the MME, SCEF, and IWK-SCEF for intra-operator use, and also for inter-operator settlements.

Note that the details of the required accounting information are outside the scope of this specification.

The NIDD vis SCEF feature shall support charging in accordance with TS 32.240 [28].

Interaction with Offline Charging systems shall be supported.

The steps from FIG. 6 are described as follows:

Step (1) UE performs Attach procedure. As part of the Attach procedure the serving node (e.g. MME) retrieves the UE's subscription data from the subscription repository (e.g. HSS). The UE's subscription data for non-IP connectivity may contain ‘policy information’ for the non-IP data. Such policy information can be but not limited to e.g. the AMBR or maximum data rate for all non-IP data, or for single non-IP PDN connection. When the UE requests the establishment of non-IP PDN connectivity during Attach procedure or as in independent procedure later, e.g. both cases are described in PDN Connectivity procedure (see TS 23.401), the serving node initiates the establishment of T6 (e.g. T6a) connection.

Step (2) The serving node sends Create SCEF Connection Request (User Identity, EPS Bearer Identity, policy information) message to the SCEF. The User Identity includes UE's IMSI, or MSISDN, or External ID(s). The combination of EPS Bearer Identity and User Identity allows the SCEF to uniquely identify the PDN connection to the SCEF for a given UE. In addition the serving node can send the ‘policy information’ parameter(s) (also known as Information Element) for the non-IP data as described above. The policy information can have the same content as received from the HSS during step (1), but it is also possible that the MME modifies the subscription policy information based on local configuration. In case that the MME does not receive policy information from the HSS, MME can derive/generate policy based on local configuration.

Step (3) When receiving the Create SCEF Connection Request message, the SCEF processes the information correspondingly. If ‘policy information’ parameter(s) is contained in the message, the SCEF start internal processes for corresponding monitoring/inspection of the non-IP data to be transmitted. The SCEF creates and sends an SCEF EPS Bearer Context for the UE ID. The SCEF sends Create SCEF Connection Response (User Identity EPS Bearer Identity) message to the MME confirming establishment of PDN connection to the SCEF for the UE.

It is possible that a particular UE can be connected to multiple SCEFs for multiple non-IP PDN connections. In such case, the serving node should derive the appropriate ‘policy information/parameters’ set for the corresponding SCEF. The serving node informs via steps (2) and (3) each SCEF with the corresponding ‘policy parameters’ during T6 connection establishment.

It is also possible that a particular UE may have multiple non-IP applications and if separate PDN connections are needed for different applications, then different APNs are used for establishment of different non-IP PDN connections. In the proposed solution in FIG. 6, this would mean that the serving node (e.g. MME) needs to generate ‘policy parameters’ set per APN or per PDN connection. These different ‘policy parameters’ set is exchanged between MME and SCEF during the T6 connection establishment.

Dynamic configuration of policy information (policy rules) is possible triggered by the MME. For example based on criteria like (1) increased UEs of the same type or (2) increased delay for transmission of non-IP data over the NAS protocol, or (3) increased load in the radio access network, or any other reason, the MME can decide to start a procedure to update the policy information in the SCEF. It is assumed that the MME is able to derive new policy information (new policy rules) based on the above mentioned criteria. It is also assumed that the MME stores the previously configured policy information to the SCEF. Once the MME derives new/updated policy information (policy rules), the MME can initiate a Configuration Update procedure towards the SCEF. Such a procedure can be e.g. T6 Connection Reconfiguration procedure initiated by the MME towards the SCEF.

FIG. 7 shows the T6 reconfiguration (or modify) procedure. Please note that this procedure can be also considered as non-IP PDN Connection or non-IP EPS bearer reconfiguration (or modification) procedure. With other words the T6 connection reconfiguration may be impacted based on the PDN connection reconfiguration. This procedure can be used to update or modify some of the non-IP PDN connection (or non-IP EPS bearer) parameters configured between the serving node MME/SGSN and SCEF. For example using this reconfiguration or modify procedure, the MME can initiate reconfiguration of some policy parameters or QoS parameters.

The steps from FIG. 7 are described as follows:

1. Based on various inputs the MME may be aware about an update of the non-IP APN parameters like policy, QoS, priority, limitations, etc. For example, as shown in step 1.1 a reconfiguration of existing connections or PDN connection update, or based on UE mobility event, or something else, the MME may be informed about the updated parameters.

In another example shown on step 1.2, the HSS may internally updated the subscription parameters which may influence the policing of data traffic, especially if update of the subscription parameters for a particular non-IP APN.

It is also possible that the MME derives new policy parameters by itself (i.e. internally).

2. The MME requests Reconfigure (or Modify) T6 Connection procedure towards the SCEF. This message can exemplary called Modify (or Reconfiguration) T6 Connection request message. This message contains the changed or updated parameters for a T6 connection, i.e. policy information, updated UE-AMBR, updated max amount of data, etc.

3. After receiving the request for reconfiguration or modification of T6 connection from the MME, the SCEF updates the UE's context (various policy or QoS parameters) stored in the SCEF. If the processing of the received message in the SCEF if successful, the SCEF sends a Modify (or Reconfiguration) T6 Connection response message.

In case that the SCEF fails to process the message from step 2) or the update of the UE's context fail, the SCEF sends a Modify (or Reconfiguration) T6 Connection response message containing a corresponding failure cause value.

Please note that the ‘T6 Reconfiguration (or Modify) procedure’ can be also used by the MME/SGSN to change MME/SGSN identities used for the T6 connection. In the reverse direction the SCEF can also inform the MME/SGSN about changed T6 end-point identifiers T6 EPI). With other words, the ‘T6 Reconfiguration (or Modify) procedure’ can be used to reconfigure (or exchange) the corresponding T6 entity about the changed T6 end-point identifiers (T6 EPI). This can be used in a similar was as the exchange of GTP TEID.

Please note the T6 Reconfiguration (or Modify) procedure can be also triggered by the SCEF towards the serving node, i.e. in the opposite direction. This may happen if the SCEF experiences certain conditions (e.g. overload, restoration, re-allocation), so that the SCEF informs the MME/SGSN about the updated T6 connection information.

Please also note that.

In one alternative solution, the MME can apply the policy information by itself, i.e. the MME counts the number of transmitted packets/NAS PDUs; or total transmitted data; or applying other data limitation parameters. If the MME detects that a certain thresholds has been hit (reached), the MME can start discarding packets or applying data limitations (throttling) for a certain time or storing a packet for certain time.

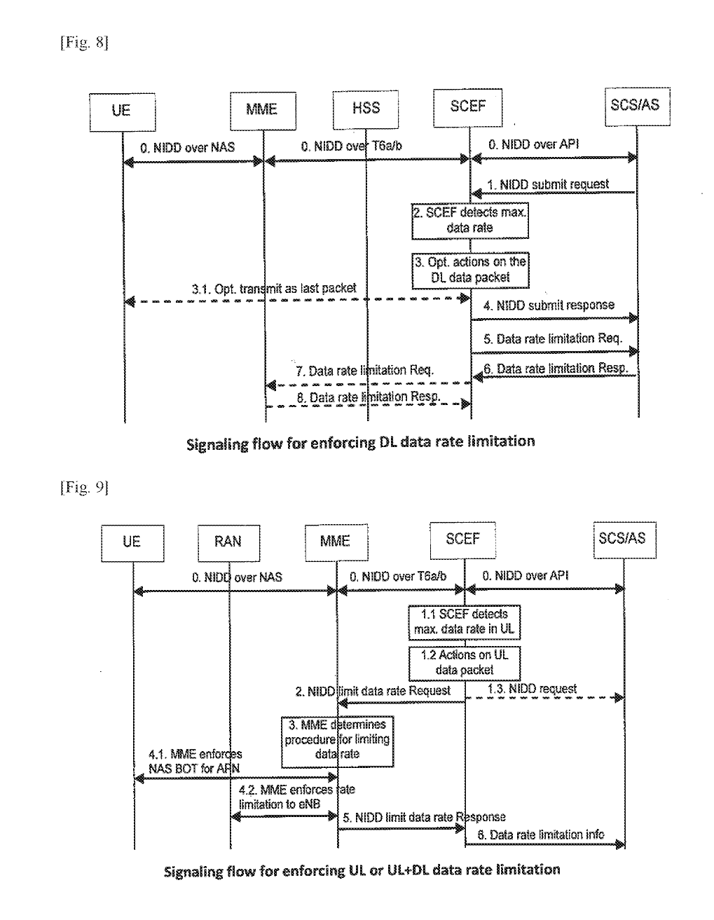

In case of downlink (DL) data, FIG. 8 shows a possible solution for enforcement of data limitation in the DL (e.g. data rate limitation like APN-AMBR, or total amount of data or number of PDU transmissions, etc).

The steps from FIG. 8 are described as follows:

Step (0) There is non-IP data bearer(s) setup between the UE and SCEF for communication with one or multiple SCS/AS.

Step (1) SCS/AS sends a DL data packet (which can be encapsulated in another protocol). This can be a NIDD Submit request (External Identifier or MSISDN, SCS/AS Reference ID, non-IP data) message sent from SCS/AS to the SCEF. This request may contain parameters like Maximum Number of NIDD, NIDD Duration, etc.

Step (2) The SCEF applies policy (data counting, transmissions counting, charging data (CDR) generation, etc.) functionality to the send/received non-IP data. The SCEF takes into consideration the parameters received in step (1) in the NIDD Submit request message. This means the policy enforcement can be either in one direction DL or UL, but also in both directions. If the SCEF determines that certain thresholds were hit (e.g. the transmitted DL data exceeds certain limit (for all bearers or for a single bearer), the SCEF can take various actions depending on preconfigured or dynamically stored policy rules.

Step (3) If the SCEF detects maximum data rate limitation, the SCEF may perform different actions on the DL data packet itself, i.e. the SCEF may discard the packet, or store the packet for later transmission or transmit the packet in the DL towards the UE as last DL packet.

Step (4) The SCEF reports the transfer of DL data towards SCS/AS. The SCEF sends NIDD Submit response (External identifier or MSISDN, SCS/AS Reference ID, success indicator, error/failure cause, time for storing or time for applying throttling/limitation) message to the SCS/AS. SCEF informs SCS/AS of delayed delivery via appropriate cause code, e.g. using time for storing indicator. If the non-IP data is discarded or not delivered due to data rate exceed, or overload or other reason, the SCEF includes corresponding error cause.

Note that the SCEF can reject the NIDD submission from the SCS/AS with a cause/failure code e.g. “max. data limit exceeded”, “max. data rate exceeded”, “overload”, “max. number of transmissions” or other and optionally including a time duration for the limitation. This can be used instead of the procedure described below in steps (5) and (6).

Step (5) The SCEF initiates procedure for data rate limitation towards the SCS/AS for the given UE or for a given application (assuming that the same SCS/AS implements multiple applications). For this purpose the SCEF sends Data rate limitation request (or similar) message to SCS/AS in order to inform the SCS/AS about the limited data rate. For example the following format of the message can be: Data rate limitation request (External Identifier or MSISDN, SCEF Reference ID, limitation cause, time duration for limitation, etc.) message.

Step (6) The SCS/AS processes the request from SCEF and replies with data rate limitation response towards the SCEF. For this purpose the SCS/AS can send Data rate limitation response message to SCEF.

For example the following format of the message can be: Data rate limitation response (External Identifier or MSISDN, SCS/AS Reference ID, Ack, time duration for limitation or time for applying throttling/limitation, error/failure cause, etc.)

Step (7) Optionally, especially in case the whole non-IP data rate for MO and MT communication has been exceeded, the SCEF can initiate a corresponding data rate limitation procedure towards the serving node (MME/SGSN). The message in this step can have a similar format as the Data rate limitation request from step (5), but using different UE and bearer/connection ID, as it is network internal message in contrast to step (5) where it can be outside the network trust domain. For example: Data rate limitation request (UE ID (e.g. IMSI), SCEF Reference ID, EPS bearer ID, limitation cause, time duration for limitation or time for applying throttling/limitation, etc.) message.

The serving node processes the message and can take immediate or late actions, e.g. (1) release of the affected nob-IP EPS bearer with a back-off timer, (2) informing the corresponding RAN node (e.g. eNB) about the data limitation in the UL for the corresponding UE or EPS bearer. A possible timer used by the MME can be derived based on e.g. the parameter ‘time duration for limitation’ received from the SCEF.

As consequence (not shown in the figure), the RAN node can enforce the limitations requested by the serving node.

Step (8) If step (7) has been performed, the serving node (MME/SGSN) replies with Data rate limitation response message, which can have similar format as the message from step (6), but using different UE ID and bearer/connection ID, as it is network internal message in contrast to step (5) where it can be outside the network trust domain.

FIG. 9 shows an example signaling flow for the solution of data rate limitation enforcement for UL data.

The steps from FIG. 9 are described as follows:

Step (0) Non-IP data bearer(s) are setup between the UE and SCEF for communication with one or multiple SCS/AS(s) for one or multiple non-IP applications.

Step (1) The SCEF applies policy configuration, which means that the SCEF applies one or multiple of the following processes/functionality: data counting, charging data (CDR) generation, data gating, AMBR enforcement, data amount etc. If the SCEF determines that the transmitted a) UL data or b) UL+DL data exceeds certain limit (for all non-IP bearers or for a single non-IP bearer), the SCEF can take various actions depending on preconfigured or stored policy rules.

In step (1.2) the SCEF can decide to transmit the data e.g. using step (1.3) NIDD request towards SCS/AS or the SCEF can decide to discard the data.

Optionally the SCEF can store the packet for later transmission (when the subscribed amount of data allows transmission) or transmit the packet in the DL towards the UE as last DL packet.

Step (2) The SCEF initiates procedure for data rate limitation (or data transmission limitation) towards the UE and MME for the whole UE non-IP traffic transmitted over the SCEF or for a given application (assuming that the same UE implements multiple applications). For this purpose the SCEF can send Data rate limitation request (or similar) message to SCS/AS in order to inform the SCS/AS about the limited data rate. For example such a format can be Data rate limitation request (External Identifier or MSISDN, SCEF Reference ID, limitation cause, time duration for limitation, etc.)

Step (3) MME determines based on the indication from the SCEF that the transmission of data should be limited.

Step (4) The MME decides which non-IP data limitation option to apply. One alternative is that MME starts enforcement of policy rules by itself, i.e. the MME counts the number of packets/NAS PDUs or total transmitted data. If the MME detects that a certain thresholds has been hit (reached), the MME can start discarding packets or applying data limitations (throttling) for a certain time or storing a packet for certain time.

(4.1) In this option. MME/SGSN use NAS (E)SM signalling to request the UE to stop or limit the transmission of non-IP data to the concerned APN. The MME can send a kind of back-off timer, or other time information during which the UE is not allowed to send information, or send only limited information (e.g. 1 data transmission per hour). The UE can acknowledge the reception of the MME.

(4.2) The MME/SGSN updates the UE's context stored in the RAN with a new max. allowed data rate. For example this can be a new UE-AMBR, or APN-AMBR. These updated parameters can apply either to UL or to DL or to both directions. The RAN node (eNB, NB, BS) starts applying the new policy enforcement parameters. If the eNB detects the a certain thresholds has been hit (reached), the eNB may decide on different action like perform RRC connection release with back-off timer, or other actions to stop the UE of sending UL data for a certain PDN connection. Although it may be difficult to differentiate the different PDN connections, if all are sent over the same SRB1/2.

Step (5) RAN node (e.g. eNB) acknowledges the successful processing of the MME's request.

In case of failure to process the request from step 4.2, the RAN node send a response with a corresponding failure/cause code value. In case of failure, the MME/SGSN can then initiate an alternative procedure to enforce the data limitation, e.g. the MME/SGSN can apply the procedure from step 4.1.

Step (6) The MME/SGSN replies to step 2 with a NIDD limit data rate Response (UE ID SCEF/MME/SGSN reference ID).

Please note that the solution in this invention are mostly described including the MME as serving node, but it is also possible to apply the solution to 2G and 3G access system, i.e. when the SGSN (or MSC) is used as serving node. In such case the T6 interface would be T6b and the corresponding procedures described above are applicable to T6b interface.

The description below applies to all solutions described in this invention.

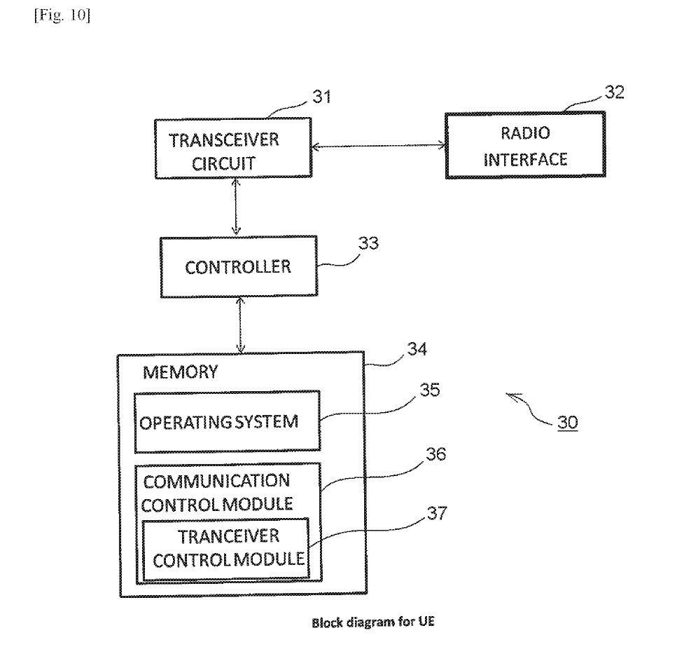

According to the example embodiments in this invention, the mobile terminal (e.g. a UE) 30 is modified to be able to handle the signaling to/from the network (particularly from the RAN node). The mobile terminal 30 can be described schematically via the block diagram as in FIG. 10:

As shown in FIG. 10, the mobile terminal (UE) 30 comprises a transceiver circuit 31 and a radio interface 32 for transmitting signal to and for receiving signals from the network (the RAN node). The mobile terminal 30 comprises a controller 33 for control of the operation of the mobile terminal 30. The controller 33 is associated with a memory 34.

Software may be pre-installed in the memory 34 and/or may be downloaded via a communication network or from a removable data storage device (RMD), for example. The controller 33 is configured to control the overall operation of the mobile terminal 30 by, in this example, program instructions or software instructions stored in the memory 34. As shown, there software instructions include, among other things, an operating system 35 and a communication control module 36.

The communication control module 36 controls the communication between the mobile terminal 30 and the network. The communication control module 36 includes a transceiver control module 37.

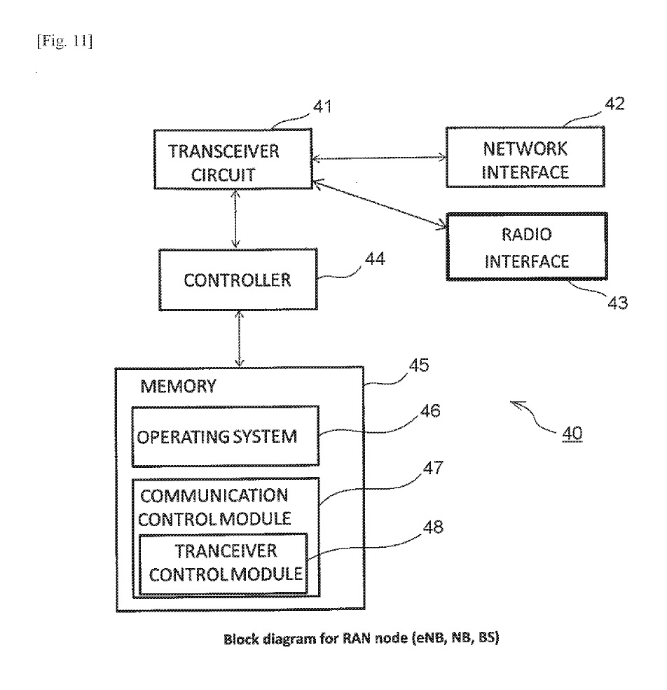

According to the example embodiments in this invention, the RAN node (e.g. eNB, NB, BS) 40 is modified to be able to handle the signaling to/from the network (to/from MME/SGSN) and to/from the UE. The RAN node 40 can be described schematically via the block diagram as in FIG. 11.

As shown in FIG. 11, the RAN node 40 comprises a transceiver circuit 41, a network interface 42 for transmitting signals to and for receiving signals from the serving node, and a radio interface 43 for transmitting signals to and for receiving signal from the mobile terminal 30. The RAN node 40 comprises a controller 44 to control the operation of he RAN node 40. The controller 44 is associated with a memory 45.

Software may be pre-installed in the memory 45 and/or may be downloaded via a communication network or from a removable data storage device (RMD), for example. The controller 44 is configured to control the overall operation of the RAN node 40 by, in this example, program instructions or software instructions stored in the memory 45. As shown, there software instructions include, among other things, an operating system 46 and a communication control module 47.

The communication control module 47 controls the communication between the RAN node 40 and the mobile terminal 30 and the communication between the RAN node 40 and the serving node. The communication control module 47 includes a transceiver control module 48.

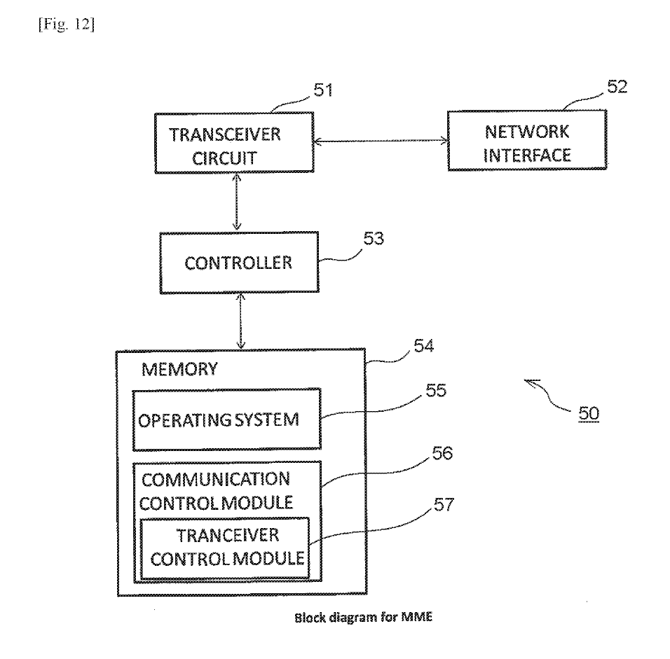

According to the example embodiments in this invention, the serving node (e.g. MME, SGSN, MSC) 50 is modified to be able to handle the signaling to/from other network functional entities (e.g. RAN node, SCEF, HSS). In addition, the MME/SGSN is able to process the received information. The MME/SGSN 50 can be described schematically via the block diagram as in FIG. 12:

As shown in FIG. 12, the serving node 50 comprises a transceiver circuit 51 and a network interface 52 for transmitting signal to and for receiving signals from other network functional entities (the RAN node 40, SCEF, HSS). The serving node 50 comprises a controller 53 for control of the operation of the serving node 50. The controller 53 is associated with a memory 54.

Software may be pre-installed in the memory 54 and/or may be downloaded via a communication network or from a removable data storage device (RMD), for example. The controller 53 is configured to control the overall operation of the serving node 50 by, in this example, program instructions or software instructions stored in the memory 54. As shown, there software instructions include, among other things, an operating system 55 and a communication control module 56.

The communication control module 56 controls the communication between the serving node 50 and the other network functional entities (the RAN node 40, SCEF, HSS). The communication control module 56 includes a transceiver control module 57.

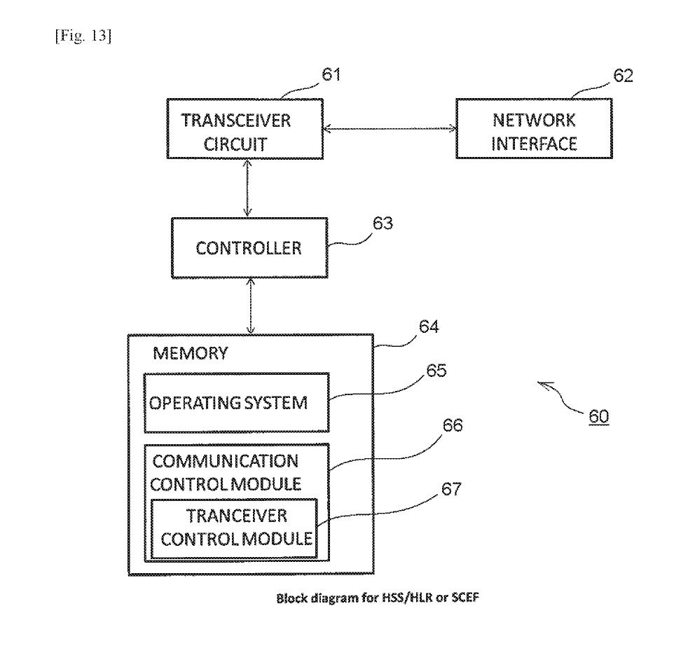

According to the example embodiments in this invention, the service exposure function (SCEF) 60 should be modified/extended to be able to behave according to the proposed solution(s). In addition HSS can be extended as well. The HSS/HLR and SCEF 60 an be described schematically via the block diagram as in FIG. 13.

As shown in FIG. 13, the HSS/HSR or SCEF 60 comprises a transceiver circuit 61 and a network interface 62 for transmitting signal to and for receiving signals from other network functional entities (the serving node 50). The HSS/HSR or SCEF 60 comprises a controller 63 for control of the operation of the HSS/HLR or SCEF 60. The controller 63 is associated with a memory 64.

Software may be pre-installed in the memory 64 and/or may be downloaded via a communication network or from a removable data storage device (RMD), for example. The controller 63 is configured to control the overall operation of the HSS/HLR or SCEF 60 by, in this example, program instructions or software instructions stored in the memory 64. As shown, there software instructions include, among other things, an operating system 65 and a communication control module 66.

The communication control module 66 controls the communication between the HSS/HLR or SCEF 60 and the other network functional entities (the serving node 50). The communication control module 66 includes a transceiver control module 67.

While the invention has been particularly shown and described with reference to example embodiments thereof, the invention is not limited these embodiments. It will be understood by those skill in the art that various changes in form and details may be made therein without departing from the spirit and scope of the present invention as defined by the claims.

This application is based upon and claims the benefit of priority from European Patent application No. EP16275028.5, filed on Feb. 17, 2016, the disclosure of which is incorporated herein in its entirety by reference.

1. A rate controlling method for non-IP data using Cellular Internet of Things (CIoT) Evolved Packet System (EPS) optimization, comprising:
limiting, by a control node for Exposure Function, a number of messages per time unit of the non-IP data based on at least one of a configured message rate control parameter in the control node and an indicated message rate control parameter by a core network node.

2. The rate controlling method according to claim 1, wherein the configured message rate control parameter includes information per Access Point Network, (APN).

3. The rate controlling method according to claim 1, further comprising:
transmitting an instruction corresponding to the configured message rate control parameter towards a user equipment, (UE), for causing the UE to comply with the instruction.

4. The rate controlling method according to claim 1, further comprising:
receiving from the core network node a create Service Capability Exposure Function (SCEF) connection request message including the indicated message rate control parameter; and
starting the limiting the number of messages per time unit of the non-IP data based on the indicated message rate control parameter.

5. The rate controlling method according to claim 4, wherein the receiving the create SCEF connection request message is performed during T6a/b connection establishment.

6. The rate controlling method according to claim 1, wherein
at least one of the configured message rate control parameter and the indicated message rate control parameter is separate for uplink and downlink.

7. The rate controlling method according to claim 1, wherein
the limiting the number of messages per time unit of the non-IP data is performed by discarding or delaying at least one packet.

8. A control node for non-IP data using Cellular Internet of Things (CIoT) Evolved Packet System (EPS) optimization, comprising:
a memory storing instructions; and
at least one processor configured to process the instructions to:
limit a number of messages per time unit of the non-IP data based on at least one of a configured message rate control parameter in the control node and an indicated message rate control parameter by a core network node.

9. The control node according to claim 8, wherein
the configured message rate control parameter includes information per Access Point Network, (APN).

10. The control node according to claim 8, wherein the processor is further configured to:
transmit an instruction corresponding to the configured message rate control parameter towards a user equipment, (UE), for causing the UE to comply with the instruction.

11. The control node according to claim 8, wherein the processor is further configured to:
receive from the core network node a create Service Capability Exposure Function (SCEF) connection request message including the indicated message rate control parameter, and
start the limiting the number of messages per time unit of the non-IP data based on the indicated message rate control parameter.

12. The control node according to claim 11, wherein the processor is further configured to:
receive the create SCEF connection request message during 6a/b connection establishment.

13. The control node according to claim 8, wherein
at least one of the configured message rate control parameter and the indicated message rate control parameter is separate for uplink and downlink.

14. The control node according to claim 8, wherein the processor is further configured to:
limit the number of messages per time unit of the non-IP data by discarding or delaying at least one packet.

15. A rate controlling method for non-IP data using Cellular Internet of Things (CIoT) Evolved Packet System (EPS) optimization, comprising:
informing a user equipment, (UE) and a control node for Exposure Function, of a message rate control that a serving Public Land Mobile Network (PLMN) intends to limit a number of messages per time unit of the non-IP data based on an indicated message rate control parameter.

16. A core network node for rate controlling of non-IP data using Cellular Internet of Things (CIoT) Evolved Packet System (EPSI optimization, comprising:
a memory storing instructions; and
at least one processor configured to process the instructions to:
inform a user equipment, (UE), and a control node for Exposure Function, of a message rate control that a serving Public Land Mobile Network (PLMN) intends to limit a number of messages per time unit of the non-IP data based on an indicated message rate control parameter.

17. A communication method used in a user equipment, (UE), for non-IP data using Cellular Internet of Things (CIoT) Evolved Packet System (EPS) optimization, comprising:
receiving a message rate control parameter from a core network node; and
limiting a number of messages per time unit at which the UE generates uplink data to comply with a policy corresponding to the message rate control parameter.

18. A User Equipment, UE, for rate controlling of non-IP data using Cellular Internet of Things (CIoT) Evolved Packet System (EPS) optimization, comprising:
a memory storing instructions; and
at least one processor configured to process the instructions to:
receive a message rate control parameter from a core network node, and
limit a number of messages per time unit at which the UE generates uplink data to comply with a policy corresponding to the message rate control parameter.

19. A system for rate controlling of non-IP data using Cellular Internet of Things (CIoT) Evolved Packet System (EPS) optimization, comprising:
a control node; and
a core network node, and wherein
the core network node is configured to inform a user equipment (UE) and the control node for Exposure Function of a message rate control that a serving Public Land Mobile Network (PLMN) intends to limit a number of messages per time unit of the non-IP data based on an indicated message rate control parameter, and
the control node is configured to limit the number of messages per time unit of the non-IP data based on at least one of a configured message rate control parameter in the control node and the indicated message rate control parameter by the core network node.

20. A non-transitory computer readable recording medium a computer program comprising computer implementable instructions for causing a programmable communications device to perform the method of claim 17.
